(19) United States
(12) Patent Application Publication
(10) Pub. No.: US 2026/0180177 A1
(43) Pub. Date: Jun. 25, 2026

(54) ANTENNA ASSEMBLY

(71) Applicant: Kyocera AVX Components (San Diego), Inc., San Diego, CA (US)

(72) Inventors: Weichun Eric Lin, San Diego, CA (US); Rey Anthony Aspiras Eguilos, Perris, CA (US)

(21) Appl. No.: 19/427,465

(22) Filed: Dec. 19, 2025

Related U.S. Application Data
(60) Provisional application No. 63/737,200, filed on Dec. 20, 2024.

(51) Int. Cl. H01Q 5/20; H01Q 1/32; H01Q 1/42

(52) U.S. Cl. CPC H01Q 5/20; H01Q 1/32; H01Q 1/42

(57) ABSTRACT

An antenna assembly is provided. The antenna assembly includes a circuit board including a ground plane. The antenna assembly further includes a first antenna including a ground tap, the ground tap being connected to the ground plane. The antenna assembly further includes a cable connected between the first antenna and the circuit board, the cable being about 25 mm or greater wherein the first antenna is configured to operate at a frequency of about 1150 MHz to about 1600 MHz.

### PRIORITY CLAIM

The present application is based on and claims priority to U.S. Provisional Application 63/737,200 having a filing date of Dec. 20, 2024, which is incorporated by reference herein.

### FIELD

The present disclosure relates generally to an antenna assembly, and more specifically to an antenna assembly having multiple antennas.

### BACKGROUND

Antennas can be used to facilitate wireless communication between devices. It can be desirable for antennas to operate with a high efficiency to improve wireless communication between devices. Antennas may be incorporated into a variety of different types of electronic devices to provide for wireless communication. An antenna assembly may include one or more antennas to facilitate wireless communication over a variety of different frequency bands/protocols.

### SUMMARY

Aspects and advantages of embodiments of the present disclosure will be set forth in part in the following description, or can be learned from the description, or can be learned through practice of the embodiments.

One example aspect of the present disclosure is directed to an antenna assembly. The antenna assembly includes a circuit board including a ground plane. The antenna assembly further includes a first antenna including a ground tap, the ground tap being connected to the ground plane. The antenna assembly further includes a cable connected between the first antenna and the circuit board, the cable being about 25 mm or greater, wherein the first antenna is configured to operate at a frequency of about 1150 MHz to about 1600 MHz.

Another example aspect of the present disclosure is directed to an antenna assembly. The antenna assembly includes a circuit board including a ground plane. The antenna assembly further includes a first antenna including a ground tap, the ground tap being connected to the ground plane. The antenna assembly further includes a cable connected between the first antenna and the circuit board, the cable being about 25 mm or greater. The antenna assembly further includes wherein the first antenna is configured to operate at a frequency of about 2.4 GHz to about 2.5 GHz.

Another example aspect of the present disclosure is directed to an electronic device. The electronic device includes an antenna assembly. The antenna assembly includes a circuit board including a ground plane. The antenna assembly further includes a first antenna including a ground tap, the ground tap being connected to the ground plane. The antenna assembly further includes a cable connected between the first antenna and the circuit board, the cable being about 25 mm or greater, wherein the first antenna is configured to operate at a frequency of about 1150 MHz to about 1600 MHz.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1A provides a cable grounded antenna assembly according to example embodiments of the present disclosure;

FIG. 1B provides a detailed view of a cable side grounding component according to example embodiments of the present disclosure;

FIG. 2 provides an antenna assembly including antenna ground taps according to example embodiments of the present disclosure;

FIG. 3 provides a vehicle including an electronic device according to example embodiments of the present disclosure;

FIG. 4 provides a block diagram depicting an example electronic device according to example embodiments of the present disclosure;

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 10% of the stated numerical value.

When tracking or monitoring the location of an electronic device, such as a vehicle containing an electronic device, it is beneficial to determine the precise location of the electronic device. This often requires multiple antennas, such as a Global Navigation Satellite System (GNSS) antenna for satellite positioning and a Bluetooth Low Energy (BLE) antenna for local communication. These tracking devices are often packaged in very small, compact housings. Therefore to connect the antennas to the circuit board, a cable may be necessary, as the antenna may not be mounted directly on the circuit board.

However, when the cable is long (e.g., longer than 25 mm), the antenna's performance becomes degraded, altering the signal. For example, a long cable can change the antenna frequency and affect the antenna performance, thereby degrading the signal and compromising the device's functionality. One example solution to this problem involves “cable side” grounding, which requires additional components such as a cable clip and clamp and a separate ground clip component being soldered to the circuit board. These additional components add cost, complexity, and are subject to long manufacturing lead times.

Example aspects of the present disclosure relate generally to an antenna assembly that avoids signal attenuation in a long cable by improving signal performance with a ground tap included in the antenna. In one embodiment, the antenna assembly includes a circuit board with a ground plane and at least one antenna (e.g., a GNSS or BLE antenna) connected to the circuit board by a signal cable. The antenna itself can include an integrated ground tap. The ground tap can be a portion of the antenna body that is physically connected to the ground plane of the PCB. In one embodiment, this connection is made using a fastening component, such as a screw, fastener, pin, etc. This ground connection is located at a specific distance from the antenna's signal feed and serves to stop or reduce the current, thereby mitigating the negative performance effects of the long cable.

The antenna assembly according to example aspects of the present disclosure can provide numerous technical benefits and advantages. For instance, by providing a ground connection on the antenna side, the antenna will not be dependent on the length of the cable. This enhances this performance of the antenna assembly and allows designers to design the antenna for the right frequency even when a long cable is used (such as due to housing constraints). Furthermore, the antenna assembly according to example aspects of the present disclosure can provide a logistical and manufacturing advantage over alternative solutions. By integrating the ground tap into the antenna structure itself, the invention can eliminate the need for additional components like specialized cable side clips and clamps on the PCB. This simplifies the assembly process, reduces the cost of materials, and avoids the long lead times associated with such specialized grounding parts.

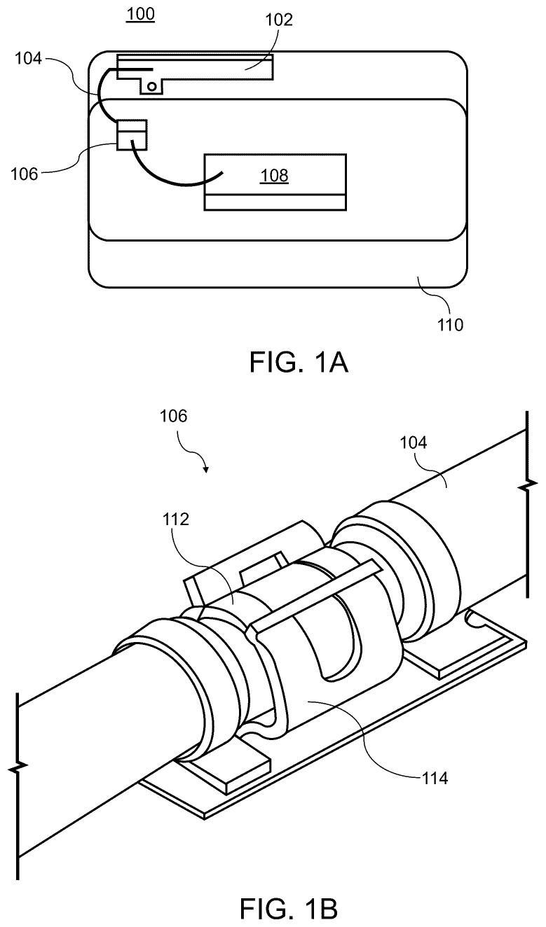

As shown in FIG. 1A, a cable grounded antenna assembly 100 is housed within a housing 110, which, in some embodiments, can include a battery pack. The housing 110 can protect the components of the cable grounded antenna assembly 100 and can provide a mounting surface for various elements of the antenna assembly 100, such as a cable grounded antenna 102. In some embodiments, the cable grounded antenna 102 is connected to a circuit board 108 by a cable 104 inside the housing 110. In some embodiments, the cable grounded antenna 102 is mounted to a side wall or surface of the housing 110. The cable grounded antenna 102 can receive and transmit Radio Frequency (RF) signals. The circuit board 108 can include processing and communication circuitry to interpret signals received by the cable grounded antenna 102 and to generate signals for transmission.

The cable 104 can be, for example, a coaxial cable. In some embodiments, the cable 104 can communicate an RF signal from the first antenna to the circuit board. Due to the routing requirements within the housing 110, the cable 104 may have a length that exceeds the optimal length for the operating frequencies of the antenna. For example, the cable routing might have a length greater than 25 mm to successfully traverse the distance from the cable grounded antenna 102 to the circuit board 108.

When the cable 104 is too long relative to the frequency of operation, the cable 104 can affect the antenna's resonant frequency, potentially degrading signal performance. To mitigate this, the assembly includes a cable side grounding component 106 positioned along the length of the cable 104. The cable side grounding component 106 is configured to mechanically and electrically engage the cable 104. In some embodiments, the cable side grounding component 106 may utilize a clip 112 and a clamp 114 to firmly grasp the exterior of the cable 104. This component creates a specific ground point on the cable shield that is distinct from the connection point on the circuit board 108.

By utilizing the cable side grounding component 106, the cable grounded antenna assembly 100 establishes a defined ground reference that isolates the antenna functionality from the remainder of the cable length. For example, the effective electrical length of the antenna system can be controlled by the position of the cable side grounding component 106 rather than the total physical length of the cable 104.

FIG. 1B provides a detailed view of a cable side grounding component according to example embodiments of the present disclosure. The cable side grounding component 106 is a multi-part assembly designed to securely engage the exterior of the cable 104 and ground the cable grounded antenna 102 on the cable side. The cable side grounding component 106 can include a clip 112 and a clamp 114, which cooperate to retain the cable 104 in a fixed position. In some embodiments, the clamp 114 serves as the structural body of the cable side grounding component 106. For example, the clamp 114 can be shaped to cradle or encircle the cable 104, ensuring substantial surface area contact with the outer shielding of the cable. This physical contact facilitates a low-impedance electrical path from the cable shield to the ground reference.

The clip 112 is a locking or retention mechanism that secures the cable 104 within the clamp 114. In some embodiments, this clip 112 may be a distinct element that snaps over the clamp 114, or it may be a part of a single device which includes both the clip 112 and the clamp 114 to exert pressure on the cable. This pressure ensures that the electrical contact between the cable shield and the clamp is not compromised by external forces (e.g., thermal expansion or mechanical shock). By grounding the shield on the cable side, the cable side grounding component 106 defines the effective electrical length of the antenna's ground plane.

The location of the cable side grounding component 106 along the cable 104 is calculated to optimize antenna performance. For example, in some embodiments, the cable side grounding component 106 can be less than about 25 mm from the cable grounded antenna 102. This distance can neutralize the negative effects of any excess cable length required for routing (such as a degraded RF signal performance). In some embodiments, the clamp 114 may be soldered directly to the PCB or snapped into a receptacle that is soldered to the PCB, thereby effectively shorting the cable shield to the system ground. However, the “cable side” grounding technique including the cable side grounding component 106, requires additional components. These additional components add cost, complexity, and are subject to long lead times. Therefore, a simplified method for grounding an antenna connected to a cable over 25 mm is desirable.

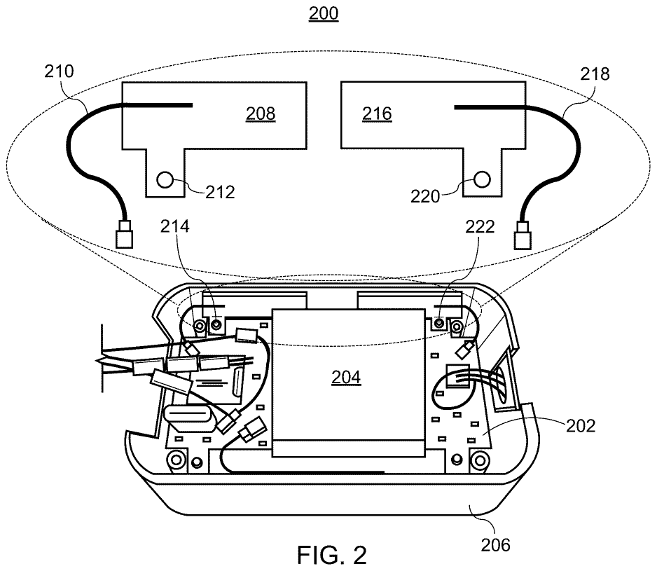

FIG. 2 provides an antenna assembly including antenna ground taps according to example embodiments of the present disclosure. In one embodiment, an antenna assembly 200 is contained within a housing 206. The housing 206 can be a non-conductive material such as polycarbonate or plastic or another dielectric material. In this way, the housing 206 can provide structural integrity while allowing Radio Frequency (RF) signals to pass through with minimal attenuation. In some embodiments, the housing 206 contains a power source, such as a battery 204. In some embodiments, the battery 204 can occupy a central portion of the housing 206, creating crowding within the housing 206, and forcing other components, particularly RF elements, to be routed around it.

A circuit board 202 can also be included in the housing. In some embodiments, the circuit board 202 can be the central hub for the device's electronics, carrying a processor, memory, and antenna communication circuitry (as detailed in FIG. 4). In some embodiments, the circuit board 202 is a Printed Circuit Board (PCB) populated with various surface-mounted components. In some embodiments, the circuit board 202 provides the electrical interfaces for power distribution from the battery 204 and signal processing for the communications modules.

In some embodiments, the antenna assembly 200 includes one or more antennas configured to operate on different frequency bands. For example, in some embodiments, the antenna assembly 200 can include a first antenna 208 and a second antenna 216. In some embodiments, the first antenna 208 can be configured to receive Global Navigation Satellite System (GNSS) reception. For example, in some embodiments, the first antenna 208 can be configured to operate at a frequency of about 1150 MHz to about 1600 MHz. In some embodiments, the first antenna 208 is a Flexible Printed Circuit (FPC) antenna. In this way, the first antenna 208 can be on a side wall of the housing 206, increasing the available space by being attached directly to housing 206.

In some embodiments, the first antenna 208 can be connected to the circuit board 202 by a cable 210. In some embodiments, the cable 210 is a coaxial cable. In some embodiments, the cable 210 can communicate RF signals between the first antenna 208 and a GNSS receiver on the circuit board 202. Due to the placement of the battery 204 and the specific mounting location of the antenna, the cable 210 often requires a routing path that exceeds the ideal electrical length for the frequency of operation. For example, in some embodiments, the cable 210 can be greater than about 10 mm, such as greater than about 25 mm, such as greater than about 50 mm, such as greater than about 100 mm. In some embodiments, the cable 210 length can alter the RF signal, shifting its resonant frequency away from the desired GNSS band and degrading performance.

To counteract this effect, the first antenna 208 can be equipped with a ground tap 212. In some embodiments, the ground tap 212 is a mounting hole configured to connect the first antenna 208 to a ground plane of the circuit board 202. In some embodiments, the ground tap 212 can be on can be a tab or protrusion of the first antenna 208. In some embodiments, the distance between the ground tap 212 and the connection point where the cable 210 attaches to the first antenna 208 can be less than about 20 mm, such as less than about 15 mm, such as less than about 10 mm, such as less than about 5 mm.

A fastening component 214 can be utilized to secure the ground tap 212 to a ground plane of the circuit board 202. The fastening component 214 can be a metallic screw or bolt. For example, the fastening component 214 can be one or more of stainless steel, aluminum, titanium, brass, copper, alloy steel, silicon bronze, or carbon steel. In some embodiments, the fastening component 214 can connect the ground tap 212 to the system ground reference, such as a ground plane in the circuit board 202 (not shown).

By connecting the fastening component 214 to the ground of the circuit board 202 through the ground tap 212, the assembly creates a low-impedance path to ground for the first antenna 208. Consequently, in some embodiments, the ground tap 212 acts as an RF choke. For example, the ground tap 212 can isolate the first antenna 208 from the parasitic inductance and capacitance of the cable 210, rendering the performance of the first antenna 208 independent of the length or routing path of the cable 210.

In some embodiments, the second antenna 216 can be configured to receive Bluetooth Low Energy communication. For example, in some embodiments, the second antenna 216 can be configured to operate at a frequency of about 2.4 GHz to about 2.5 GHz. In some embodiments, the second antenna 216 is a FPC antenna. In this way, the second antenna 216 can be on a side wall of the housing 206, optimizing the available space by being attached directly to housing 206.

While FIG. 2 discloses the first antenna 208 being configured to receive a GNSS signal and the second antenna 216 being configured to receive a BLE signal, both the first antenna 208 and the second antenna 216 can be configured to receive a variety of RF signal frequencies, and in some embodiments, may be switched in terms of the RF frequencies they receive (e.g., the first antenna 208 receiving a BLE signal and the second antenna 216 receiving a GNSS signal).

Aspects of the present disclosure are discussed with respect to example frequency ranges. Those of ordinary skill in the art, using the disclosures provided herein, will understand that the present technology can be used with other frequency ranges without deviating from the scope of the present disclosure.

In some embodiments, one or both of the first antenna 208 and the second antenna 216 can be configured to receive an RF signal such as an Extremely Low Frequency (ELF) band, including a frequency of about 3 Hz to about 30 Hz, such as a Super Low Frequency (SLF) band, including a frequency of about 30 Hz to about 300 Hz, such as a Ultra Low Frequency (ULF) band, including a frequency of about 300 Hz to about 3 kHz, such as a Very Low Frequency (VLF) band, including a frequency of about 3 kHz to about 30 kHz, such as a Low Frequency (LF) band, including a frequency of about 30 kHz to about 300 kHz, such as a Medium Frequency (MF) band, including a frequency of about 300 kHz to about 3 MHz, such as a High Frequency (HF) band, including a frequency of about 3 MHz to about 30 MHz, such as a Very High Frequency (VHF) band, including a frequency of about 30 MHz to about 300 MHz, such as a Ultra High Frequency (UHF) band, including a frequency of about 300 MHz to about 1 GHz (IEEE) or up to about 3 GHz (ITU).

In some embodiments, one or both of the first antenna 208 and the second antenna 216 can be configured to receive an RF signal in the microwave and radar spectrum, such as the S band, including a frequency of about 2 GHz to about 4 GHZ, such as the C band, including a frequency of about 4 GHz to about 8 GHZ, such as the X band, including a frequency of about 8 GHz to about 12 GHz, such as the Ku band, including a frequency of about 12 GHz to about 18 GHz, such as the K band, including a frequency of about 18 GHz to about 27 GHZ, such as the Ka band, including a frequency of about 27 GHz to about 40 GHz, such as the V band, including a frequency of about 40 GHz to about 75 GHz, such as the W band, including a frequency of about 75 GHz to about 110 GHz, such as the millimeter-wave (mmWave) band, including a frequency of about 110 GHz to about 300 GHz.

In some embodiments, one or both of the first antenna 208 and the second antenna 216 can be configured to receive an RF signal in the GNSS range, such as the L1 band, centered at a frequency of about 1575.42 MHz, such as the L2 band, centered at a frequency of about 1227.60 MHz, such as the L3 band, centered at a frequency of about 1381.05 MHz, such as the L4 band, centered at a frequency of about 1379.91 MHz, such as the L5 band, centered at a frequency of about 1176.45 MHz.

In some embodiments, the second antenna 216 can be connected to the circuit board 202 by a second cable 218. In some embodiments, the second cable 218 is a coaxial cable. In some embodiments, the second cable 218 can communicate RF signals picked up by the second antenna 216 back to a BLE receiver on the circuit board 202. Due to the placement of the battery 204 and the specific mounting location of the antenna, the second cable 218 often requires a routing path that exceeds the ideal electrical length for the frequency of operation. For example, in some embodiments, the second cable 218 can be greater than about 10 mm, such as greater than about 25 mm, such as greater than about 50 mm, such as greater than about 100 mm. In some embodiments, the second cable 218 length can alter the RF signal, shifting its resonant frequency away from the desired BLE band and degrading signal acquisition performance.

To counteract this effect, the second antenna 216 can be equipped with a second ground tap 220. In some embodiments, the second ground tap 220 is a mounting hole configured to connect the second antenna 216 to a ground plane of the circuit board 202. In some embodiments, the second ground tap 220 can be on can be a tab or protrusion of the second antenna 220. In some embodiments, the distance between the second ground tap 220 and the connection point where the second cable 218 attaches to the second antenna 216 can be less than about 20 mm, such as less than about 15 mm, such as less than about 10 mm, such as less than about 5 mm.

A second fastening component 222 can be utilized to secure the second ground tap 220 to a ground plane of the circuit board 202. The second fastening component 222 can be a metallic screw or bolt. For example, the second fastening component 222 can be one or more of stainless steel, aluminum, titanium, brass, copper, alloy steel, silicon bronze, or carbon steel. In some embodiments, the second fastening component 222 can connect the second ground tap 220 to the system ground reference, such as a ground plane in the circuit board 202 (not shown).

By connecting the second fastening component 222 to the ground of the circuit board 202 through the second ground tap 220, the assembly creates a low-impedance path to ground for the second antenna 216. Consequently, in some embodiments, the second ground tap 220 acts as an RF choke. For example, the second ground tap 220 can isolate the second antenna 216 from the parasitic inductance and capacitance of the second cable 218, rendering the performance of the second antenna 216 independent of the length or routing path of the second cable 218.

Additionally, the symmetrical arrangement of the first antenna 208 and the second antenna 216 with their respective ground taps allows for a highly modular manufacturing process. Furthermore, the use of fastening components provides mechanical rigidity to the antennas. In a high-vibration environment such as a moving vehicle, adhering an antenna solely with adhesive might lead to peeling or shifting over time. The fastening components (e.g., screws) provide a mechanical connection that keeps the antennas in their designed positions, while simultaneously grounding the antennas on the antenna side. In this way, the antenna assembly 200 can utilize ground taps and fastening components on the antenna side to generate consistent, high-performance RF connectivity for both GNSS and BLE frequency bands regardless of a cable length connecting the antenna to a circuit board.

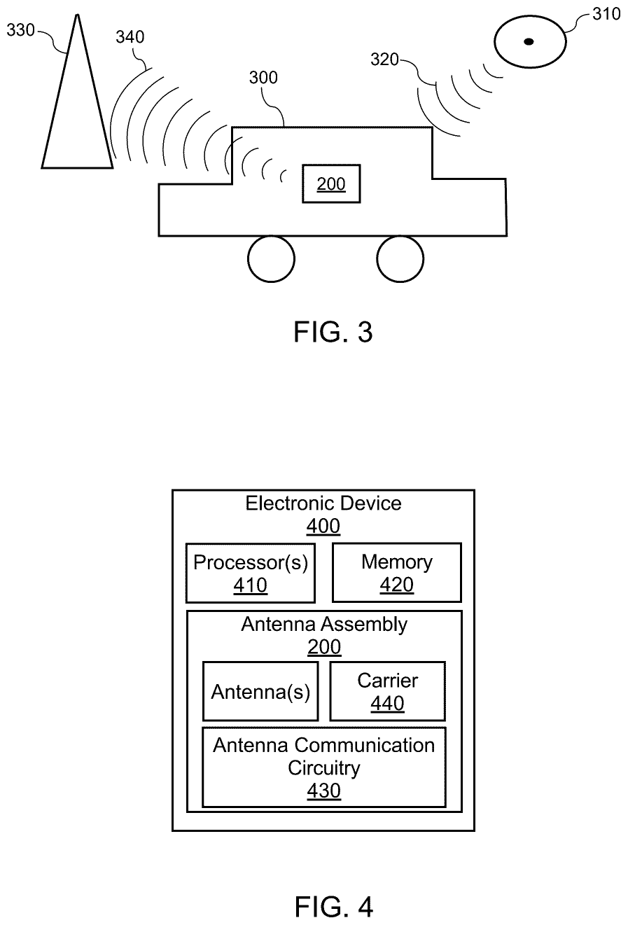

FIG. 3 provides a vehicle including an electronic device according to example embodiments of the present disclosure. A vehicle 300 can include the antenna assembly 200, which is typically integrated into an electronic device, such as a stolen vehicle recovery unit, mounted within the vehicle 300. In some embodiments, the antenna assembly 200 is configured to facilitate wireless communication to track and recover the vehicle 300. In some embodiments, the vehicle 300 is in communication with a satellite 310, such as with the first antenna 208. The satellite 310 can transmit an RF signal 320, which can be received by the antenna assembly 200 located within or upon the vehicle 300. In some embodiments, the RF signal 320 corresponds to a Global Navigation Satellite System (GNSS) signal, such as a GPS, which allows the electronic device connected to the antenna assembly 200 to determine the location of the vehicle 300.

The antenna assembly 200 can further communicate with a tower 330 (such as, for example, a tower configured to communicate Bluetooth Low Energy signals), such as with the second antenna 216. The tower 330 transmits or exchanges a second RF signal 340 with the vehicle 300. The second RF signal 340 can be a Bluetooth Low Energy signal, which is utilized for short-range communication, identification, or beaconing purposes to assist in locating the vehicle 300 when it is in range of the appropriate infrastructure (e.g., such as any tower 330).

Due to spacing concerns within the vehicle 300, the antenna assembly 200 may be mounted in specific locations where space is constrained or where reception is not optimized, such as under a dashboard or within a body panel. In some embodiments, the cables connecting the antenna(s) (such as the first antenna 208 and the second antenna 216) to the circuit board 202 may be long to accommodate the requirements of the vehicle 300. In some embodiments, such as when the cables are long (e.g., at least about 25 mm) the implementation of the ground tap on the antenna assembly 200 can help ensure that the impedance and frequency characteristics of the antennas are preserved, maximizing the range and signal quality of the RF signal 320 and the second RF signal 340.

In some embodiments, when the antenna assembly 200 is sending or receiving RF signals, the processor 410 can process one or more RF signals (e.g., the RF signal 320) received via the antenna assembly 200 to calculate coordinates for the electronic device, and therefore the vehicle 300. In some embodiments, the antenna assembly 200 can simultaneously monitor for the second RF signal 340 from the tower 330 or can be transmitting the second RF signal 340 to a tower 330. In this way, a more accurate determination of the location of the antenna assembly 200 can be made, even, for example, during movement of the electronic device such as in a moving vehicle 300. By neutralizing the parasitic effects of the cabling required to traverse the interior of the vehicle 300, the system ensures that the vehicle 300 maintains consistent connectivity with external positioning and communication networks (e.g., satellite 310 and tower 330), thereby enabling precise tracking and recovery operations.

FIG. 4 provides a block diagram depicting an example electronic device according to example embodiments of the present disclosure. Electronic device 400 may be any suitable electronic device configured to have wireless communication with one or more remote devices. For instance, electronic device 400 can be a computing device (e.g., laptop, desktop, display with one or more processors), mobile device (e.g., phone, tablet, wearable device (e.g., watch)), vehicle, nautical vehicle, aircraft, satellite, keyless entry device, or other electronic device. While electronic device 400 is described in FIG. 4 with reference to antenna assembly 200 as shown in FIG. 1, those of ordinary skill in the art, using the disclosures provided herein, will understand that any aspect of antenna assembly 200 described herein can be implemented in electronic device 400 for use in a variety of applications without deviating from the scope of the present disclosure. As shown in FIG. 4, electronic device 400 includes an antenna assembly, such as antenna assembly 200 as provided herein. In some embodiments, electronic device 400 may include an antenna cabinet configured to house (e.g., at least partially house) the antenna assembly 200. As previously described, antenna assembly 200 may include a carrier 440, and a plurality of antennas, such as first antenna 208 and second antenna 216 depicted in FIG. 2. In some embodiments, the first antenna 208 and the second antenna 216 can be positioned on a first surface of the carrier 440.

Antenna assembly 200 may further include communication circuitry 430. For instance, as shown in FIG. 2, each of the first antenna 208 and the second antenna 216 may be coupled to RF circuitry via electrical cables 210, 218. Communication circuitry 430 may include electrical components (e.g., radio frequency (RF) circuitry, transmission line, transceiver, receiver, transmitter, matching circuit etc.) configured to facilitate communication of information over the antenna. In some embodiments, processor(s) 410 may be in electrical communication with antenna assembly 200 via communication circuitry 430. In this manner, RF signals received at antenna assembly 200 may be provided to processor(s) 410 via communication circuitry 430. In addition, the one or more processor(s) 410 may be configured to provide data to the antenna assembly 200 via communication circuitry 430 (e.g., electrical connectors or electrical cables of communication circuitry 430). RF signals and/or a control signal may be communicated over a transmission line (e.g., coaxial cable) of communication circuitry 430. Each electrical connector may be coupled to RF circuitry configured to communicate with processor(s) 410 via a network cable, such as an ethernet cable, to facilitate communication of information over the antennas 208, 216.

In some embodiments, electronic device 400 may further include memory 420 and one or more processor(s) 410. Processor(s) 410 can include any suitable processing device and may be configured to perform a variety of computer implemented functions. As used herein, the term “processor” refers not only to integrated circuits referred to in the art as being included in a computer, but may also refer to a microprocessor, CPU, GPU, controller, microcontroller, a microcomputer, a programmable logic controller (PLC), an application specific integrated circuit (ASIC), a Field Programmable Gate Array (FPGA), and/or other programmable circuits. As shown, electronic device 400 may further include memory 420. Examples of memory 420 can include computer-readable media including, but not limited to, non-transitory computer-readable media, such as RAM, ROM, hard drives, flash drives, or other suitable memory devices. Memory 420 can store information accessible by the one or more processor(s) 410, including computer-readable instructions that can be executed by the one or more processor(s) 410. For example, the computer-readable instructions can be software written in any suitable programming language or may be implemented in hardware. In some embodiments, the one or more processor(s) 410 along with memory 420 may be defined as one or more control devices configured to control operation of antenna assembly 200.

In some embodiments, electronic device 400 may further include one or more screen(s) (e.g., display screen, touch screen) and/or one or more input device(s) (e.g., keypad, touch pad, keyboard).

One example aspect of the present disclosure is directed to an antenna assembly. The antenna assembly includes a circuit board including a ground plane. The antenna assembly further includes a first antenna including a ground tap, the ground tap being connected to the ground plane. The antenna assembly further includes a cable connected between the first antenna and the circuit board, the cable being about 25 mm or greater, wherein the first antenna is configured to operate at a frequency of about 1150 MHz to about 1600 MHz.

In some examples, the antenna assembly further includes a fastening component connecting the ground tap to the ground plane.

In some examples, the fastening component includes one or more of stainless steel, aluminum, titanium, brass, copper, alloy steel, silicon bronze, or carbon steel.

In some examples, the antenna assembly further includes a housing, wherein the first antenna is on a side wall of the housing.

In some examples, the first antenna is not mounted to a surface of the circuit board.

In some examples, the antenna assembly further includes a second antenna including a second ground tap, the second ground tap being connected to the ground plane.

In some examples, the antenna assembly further includes a second fastening component connecting the second ground tap to the ground plane.

In some examples, the cable is configured to communicate an RF signal from the first antenna to the circuit board.

Another example aspect of the present disclosure is directed to an antenna assembly. The antenna assembly includes a circuit board including a ground plane. The antenna assembly further includes a first antenna including a ground tap, the ground tap being connected to the ground plane. The antenna assembly further includes a cable connected between the first antenna and the circuit board, the cable being about 25 mm or greater, wherein the first antenna is configured to operate at a frequency of about 2.4 GHz to about 2.5 GHz.

In some examples, the antenna assembly further includes a fastening component connecting the ground tap to the ground plane.

In some examples, the fastening component includes one or more of stainless steel, aluminum, titanium, brass, copper, alloy steel, silicon bronze, or carbon steel.

In some examples, the antenna assembly further includes a housing, wherein the first antenna is on a side wall of the housing.

In some examples, the first antenna is not mounted to a surface of the circuit board.

In some examples, the antenna assembly further includes a second antenna including a second ground tap, the second ground tap being connected to the ground plane.

In some examples, the antenna assembly further includes a second fastening component connecting the second ground tap to the ground plane.

In some examples, the cable is configured to communicate an RF signal from the first antenna to the circuit board.

Another example aspect of the present disclosure is directed to an electronic device. The electronic device includes an antenna assembly including a circuit board including a ground plane. The antenna assembly further includes a first antenna including a ground tap, the ground tap being connected to the ground plane. The antenna assembly further includes a cable connected between the first antenna and the circuit board, the cable being about 25 mm or greater, wherein the first antenna is configured to operate at a frequency of about 1150 MHz to about 1600 MHz.

In some examples, the electronic device further includes a second antenna including a second ground tap, the second ground tap being connected to the ground plane.

In some examples, the electronic device further includes a second fastening component connecting the second ground tap to the ground plane.

In some examples, a vehicle includes the electronic device.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna assembly, comprising:
a circuit board including a ground plane;
a first antenna including a ground tap, the ground tap being connected to the ground plane; and
a cable connected between the first antenna and the circuit board, the cable being about 25 mm or greater;
wherein the first antenna is configured to operate at a frequency of about 1150 MHz to about 1600 MHz.

2. The antenna assembly of claim 1, further comprising a fastening component connecting the ground tap to the ground plane.

3. The antenna assembly of claim 2, wherein the fastening component comprises one or more of stainless steel, aluminum, titanium, brass, copper, alloy steel, silicon bronze, or carbon steel.

4. The antenna assembly of claim 1, further comprising a housing, wherein the first antenna is on a side wall of the housing.

5. The antenna assembly of claim 1, wherein the first antenna is not mounted to a surface of the circuit board.

6. The antenna assembly of claim 1, further comprising a second antenna including a second ground tap, the second ground tap being connected to the ground plane.

7. The antenna assembly of claim 6, further comprising a second fastening component connecting the second ground tap to the ground plane.

8. The antenna assembly of claim 1, wherein the cable is configured to communicate an RF signal from the first antenna to the circuit board.

9. An antenna assembly, comprising:
a circuit board including a ground plane;
a first antenna including a ground tap, the ground tap being connected to the ground plane; and
a cable connected between the first antenna and the circuit board, the cable being about 25 mm or greater;
wherein the first antenna is configured to operate at a frequency of about 2.4 GHz to about 2.5 GHz.

10. The antenna assembly of claim 9, further comprising a fastening component connecting the ground tap to the ground plane.

11. The antenna assembly of claim 10, wherein the fastening component comprises one or more of stainless steel, aluminum, titanium, brass, copper, alloy steel, silicon bronze, or carbon steel.

12. The antenna assembly of claim 9, further comprising a housing, wherein the first antenna is on a side wall of the housing.

13. The antenna assembly of claim 9, wherein the first antenna is not mounted to a surface of the circuit board.

14. The antenna assembly of claim 9, further comprising a second antenna including a second ground tap, the second ground tap being connected to the ground plane.

15. The antenna assembly of claim 14, further comprising a second fastening component connecting the second ground tap to the ground plane.

16. The antenna assembly of claim 9, wherein the cable is configured to communicate an RF signal from the first antenna to the circuit board.

17. An electronic device, comprising:
an antenna assembly comprising:
a circuit board including a ground plane;
a first antenna including a ground tap, the ground tap being connected to the ground plane; and
a cable connected between the first antenna and the circuit board, the cable being about 25 mm or greater;
wherein the first antenna is configured to operate at a frequency of about 1150 MHz to about 1600 MHz.

18. The electronic device of claim 17, further comprising a second antenna including a second ground tap, the second ground tap being connected to the ground plane.

19. The electronic device of claim 18, further comprising a second fastening component connecting the second ground tap to the ground plane.

20. A vehicle, the vehicle comprising the electronic device of claim 17.
